(19) United States
(12) Patent Application Publication
(10) Pub. No.: US 2009/0233634 A1
(43) Pub. Date: Sep. 17, 2009

(54) PUBLIC WARNING SYSTEM FOR MOBILE DEVICES

(75) Inventors: Behrouz Aghili, Commack, NY (US); Marian Rudolf, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/404,914

(22) Filed: Mar. 16, 2009

Related U.S. Application Data
(60) Provisional application No. 61/037,057, filed on Mar. 17, 2008.
(60) Provisional application No. 61/055,509, filed on May 23, 2008.

(51) Int. Cl. H04W 4/12

(52) U.S. Cl. 455/466

(57) ABSTRACT

A global system for mobile communications (GSM) enhanced data rate for GSM evolution (EDGE) radio access network (GERAN) compatible wireless transmit/receive unit (WTRU) and methods for receiving public warning system (PWS) messages via paging channels. The PWS messages may include earthquake and tsunami warning system (ETWS) messages. The PWS messages may include primary messages and secondary messages. A corresponding GERAN base station and methods capable of transmitting PWS messages.

### CROSS REFERENCE TO RELATED APPLICATIONS

This application claims the benefit of U.S. Provisional Application No. 61/037,057 filed on Mar. 17, 2008, and U.S. Provisional Application No. 61/055,509 filed on May 23, 2008, which are incorporated herein by reference as if fully set forth.

### TECHNICAL FIELD

The subject matter disclosed relates to wireless communications.

### BACKGROUND

Public Warning Systems (PWS) are of great utility in the modern world. Traditionally, PWS have been implemented in many parts of the world by relying upon conventional radio (AM, FM, and the like) and/or television (TV) Emergency Broadcast channels to urgently announce the occurrence of events that pose significant threats in terms of life or property within a certain geographical area.

Due to the widespread availability of cellular networks, both in terms of cellular coverage and handset penetration rates, the use of cellular radio systems has become a viable alternative to replace or supplement radio/TV delivery mechanisms for PWS messages. Cellular technologies which may be used for this purpose include the global system for mobile communication (GSM) general packet radio service (GPRS) and enhanced GPRS (EGRPS). The Third Generation Partnership Project (3GPP) recently approved the Earthquake Tsunami Warning Systems (ETWS) work item to develop standardized approaches to cellular PWS. By definition, the ETWS is a subset of the PWS. For simplicity, PWS is used herein to refer to both PWS and ETWS.

In GSM/GPRS/EGPRS, a wireless transmit/receive unit (WTRU) may be attached to both a circuit switched (CS) (GSM) domain and a packet switched (PS) (GPRS) domain at the same time. In the CS domain, the WTRU may be either in Idle Mode or Dedicated Mode. In the PS domain, the WTRU may be in either Packet Idle Mode or Packet Transfer Mode. The modes of operation in CS and PS are independent, which means that a WTRU may be in CS Dedicated Mode and PS Packet Idle Mode at the same time.

PWS systems pose significant technical design challenges in terms of delivery guarantees, notification timeliness, information accuracy and the amount of detail required to deliver useful PWS messages to users. Although GSM/GPRS/EGPRS systems provide great power, flexibility and control in terms of what can be delivered and how fast it can be delivered, many obstacles must be overcome before an effective mobile PWS system can be realized.

One obstacle is that PWS messages need to preempt ongoing communications, whether the communications are CS or PS voice, ongoing data communications, or dedicated signaling. This is not always possible with conventional systems, depending upon the chosen PWS delivery mechanism (for example, paging, short message service (SMS) messaging, and the like). A related issue is that the PWS notifications need to simultaneously reach a great number of WTRUs in a short amount of time.

Another issue is that PWS messages need to reach a WTRU in Idle Mode, but GSM/GPRS/EGPRS WTRUs in Idle Mode are subject to discontinuous reception (DRX)/paging wake-up cycles reaching up to several seconds or more which cannot be reduced without significant impact on battery life and stand-by times. Because reliability forces network operators to send pages more than once, an immediate consequence is that the delivery of pages, or PWS messages, can only be guaranteed to a percentage of WTRUs over time periods extending up to several tens of seconds in duration. For many emergency events (such as earthquakes), warnings are issued only a few seconds before the actual occurrence of the event. Thus, a delay of more than a few seconds would render the warning completely ineffective.

Current systems also have restrictive payload limitations when delivering PWS messages to handsets using fast notification methods such as paging-based, cell broadcast system (CBS) based messaging, or SMS-based and similar methods. This is of particular importance for the primary PWS notification which tends to have very stringent requirements on delivery time (several seconds or less). For example, current PWS messages include overhead information including “transaction ID”, “preferred WTRU behavior”, “emergency type”, message security fields, and the like that limits the actual emergency message to a length of only a few tens of octets. In many cases, this may prove too short to accommodate the full PWS message. An additional challenge, relative to the payload limitation, arises from the fact that modern cellular systems (GSM/GPRS/EGPRS, wireless code division multiple access (WCDMA)/Long Term Evolution (LTE)) may require even more control information and may need to account for different languages, all of which will further reduce the amount of space available for the PWS message.

A primary/secondary notification system may be used in order to quickly notify a large number of WTRUs of an emergency situation by way of a primary notification that is followed by a secondary notification containing additional information. The secondary notification may include information that is specific to a WTRU or group of WTRUs based on, for example, geographic location, proximity to a specific event, and the like. The primary notification is absolutely time critical, while the secondary notification may lag slightly.

### BRIEF DESCRIPTION OF THE DRAWINGS

A more detailed understanding may be had from the following description, given by way of example and to be understood in conjunction with the accompanying drawings wherein:

FIG. 1 is a flow diagram of a PWS based on WTRU mode;

FIG. 2 is a signal flow diagram illustrating the use of System Information messaging to convey PWS information;

FIG. 3 is an illustration of the use of paging resources to convey PWS information;

FIG. 4 is a flow diagram of a method for using paging resources to convey PWS information; and

FIG. 5 is a block diagram of a WTRU and a base station configured to implement the PWS disclosed herein.

### SUMMARY

In order to provide a PWS for use in GERAN networks, base stations may transmit PWS messages over paging channels to idle mode WTRUs. DRX cycles of WTRUs may be analyzed and a PWS message may be transmitted over a paging channel for a period of time such that all WTRUs associated with a base station will receive the PWS message, regardless of the WTRUs DRX cycle.

When WTRUs are in dedicated mode or packet transfer mode, the PWS message may be conveyed via the dedicated resource. A new message may carry the PWS message or the PWS message may be inserted into a currently existing message.

### DETAILED DESCRIPTION

When referred to herein, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to herein, the terminology “base station” includes but is not limited to a Node-B, a site controller, an access point (AP), or any other type of interfacing device capable of operating in a wireless environment.

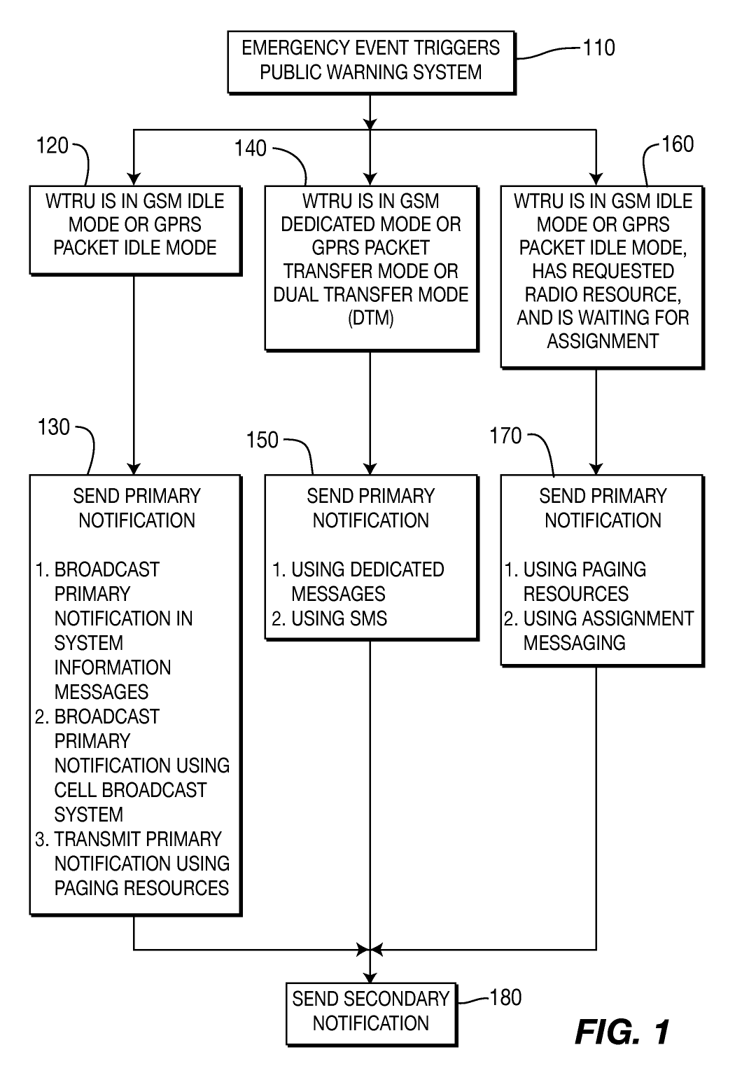

In order to overcome the problems discussed above and provide a PWS that is capable of carrying payloads of adequate size to multiple WTRUs quickly, various solutions follow that depend on the operating state of the WTRU. Referring to FIG. 1, an emergency event triggers 110 the public warning system. In a scenario 120 where a WTRU is in GSM Idle mode (CS domain) or the WTRU is in GPRS Packet Idle mode (PS domain), a primary notification is transmitted 130 by a base station to the WTRU. The primary notification is transmitted 130 to the WTRU via a system information message broadcast by the base station, via paging resources, or via CBS messaging. In a scenario 140 where a WTRU is in GSM Dedicated mode (CS domain) or GPRS Packet Transfer mode (PS domain) or Dual Transfer Mode (DTM), the WTRU has an active radio resource. This active resource allows a primary PWS notification to be sent 150 via dedicated messaging or using short messaging service (SMS) messaging. In the unique scenario 160 where a WTRU is in GSM Idle mode (CS domain) or GPRS Packet Idle mode (PS domain), and the WTRU has requested a radio resource but has not yet received a resource assignment message, a primary notification may be sent 170 using paging resources or it may be included in an assignment message. A secondary notification message may then be sent 180 at an appropriate time containing additional information regarding the emergency situation. The scenario specific techniques for communicating a primary notification 130, 150, 170, as well as corresponding secondary notification message 180, will now be described in greater detail.

In the event that a WTRU is in GSM Idle mode (attached to the CS domain) or GPRS Packet Idle mode (attached to the PS domain) (scenario 120 of FIG. 1), a new field or Information Element (IE) may be added to the System Information (or Packet System Information) message(s) indicating System Information messages will be used for broadcasting PWS information. Subsequently transmitted System Information messages may then be used for communicating both primary notifications and secondary notifications. Additionally, upon an emergency event that triggers the PWS, the base station may use the remaining resources in a multi-frame for sending the warning messages (resources that are typically used for sending other System Information messages and/or the assignment/paging messages). This means that the network may use all of the blocks that are reserved for Common Control Channels (CCCH) on the broadcast control channel (BCCH) carrier. In the case where there exists a packet common control channel (PCCCH) in the cell, the network will similarly use all the blocks (designated “B0” through “B11”) on the PCCCH time slot.

In either case, the network shall send the notification for a sufficiently long period of time in order to comply with current technical requirements. In particular, it is currently required that a PWS primary notification be delivered over a four second time period. Since various WTRUs operating in a given geographic region will likely have differing DRX schedules, this time period will ensure the PWS primary notification is received by all WTRUs.

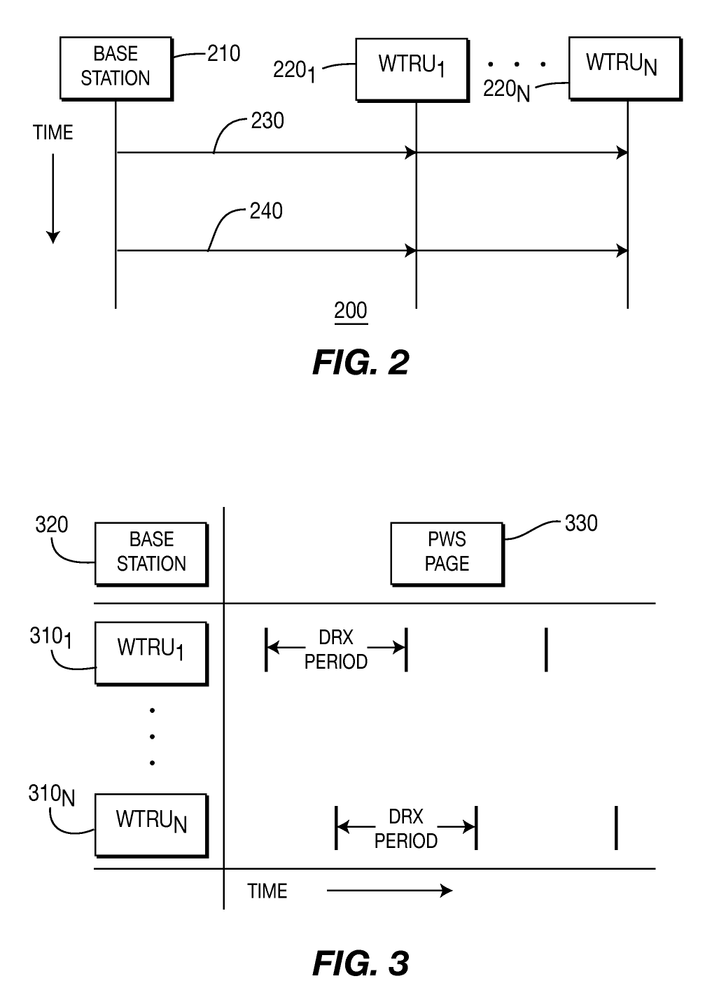

Referring to FIG. 2, a signal flow diagram 200 illustrates use of System Information messages for a mobile PWS. A base station 210 serves a plurality of WTRUs, 220₁, 220_{N}. A first System Information message 230 is broadcast to the plurality of WTRUs, 220₁, 220_{N}, and includes an indication of PWS support by the base station 210. After some emergency event triggers activation of the PWS, the base station 210 broadcasts another System Information message 240 to the plurality of WTRUs, 220₁, 220_{N}, that includes a primary notification of the emergency. The System Information message 240 may also include the indication of PWS support as in System Information message 230.

In order to optimize the use of System Information messaging for PWS, a WTRU may be preconfigured with various PWS messages or components of PWS messages that correspond to particular emergency categories and/or actions. This preconfigured PWS information may include emergency category, action codes, immediacy of emergency event, location of emergency event, and/or other PWS data fields. This preconfigured information may be stored in the WTRU in any appropriate storage medium, such as a subscriber identity module (SIM), and may be stored in any appropriate structure, such as a look-up table.

Table 1 illustrates a possible set of codes and corresponding emergency situations. The code points allow operator definable emergency descriptions that provide users a great deal of information while utilizing minimal data capacity in over-the-air messaging.

TABLE 1

| Emergency Code | Emergency Description |
|---|---|
| 1 | Tsunami |
| 2 | Earthquake |
| 3 | Shooting |
| . . . | . . . |

Table 2 below shows another example of preconfigured information indicating the duration of a given emergency event.

TABLE 2

| Code | Duration |
|---|---|
| 1 | Next 10 Minutes |
| 2 | Next Hour |
| 3 | Next 1-2 Hours |
| . . . | . . . |

When an event occurs that triggers the PWS system, the network may send a System Information message containing short code(s) and/or type field(s) corresponding to full PWS notification messages as described above. The WTRU may then receive the message, decode the short code(s) and then perform a look-up procedure of the preconfigured PWS information to determine the actual corresponding PWS message and/or action and display it to the user in a manner appropriate to the capabilities of a particular WTRU. The WTRU may also take corresponding actions (such as pre-empting ongoing voice calls, and the like).

This method is independent of the actual delivery mechanism used by the network and therefore will apply to dedicated PWS notification messaging services and other types of messaging services such as Paging, short message service (SMS), Cell Broadcast System (CBS), that will be described below in greater detail.

The content of the PWS messages may alternatively be compressed using approaches such as, for example, Huffmann coding, symbol codes, stream codes, integer codes, and the like. Use of these coding techniques includes the exchange of “code tables” or probability tables that are similar in principle to the preconfigured PWS information as described above.

As briefly mentioned above, preconfigured PWS information may be stored on a Universal Telecommunications System (UMTS) subscriber identity module (USIM)/Universal Integrated Circuit Card (UICC) of the WTRU, or in any other volatile or non-volatile memory structure of the WTRU.

Alternatively, the base station may transmit PWS configuration information using any one of or combination of an Internet protocol (IP)-based server using configuration protocols and over-the-air messaging, Open Mobile Alliance (OMA) messaging, radio resource control (RRC) messaging, non-access stratum (NAS) messaging, and WTRU firmware updates (over-the-air or through proprietary means such as universal serial bus (USB) and the like).

Alternatively, a WTRU may be preconfigured with code points that allow for multi-lingual support of PWS messaging. The lookup table may contain multiple language codes for each PWS code or component. Alternatively, there may be more than one stored entry in the look-up table(s) corresponding to a given PWS or component code. This may be desirable for operators in regions where multiple languages are commonly spoken.

Similar to broadcasting System Information messages containing PS information, CBS messaging may also be used for disseminating PWS messaging to WTRUs. A base station may indicate to an associated WTRU that CBS is “on” in the cell. The WTRU may then decode the indicated Cell Broadcast Channel (CBCH) and receive the PWS information.

In addition to or in place of System Information messaging and/or CBS messaging, PWS information may be disseminated via paging resources to WTRUs in GSM Idle mode and GPRS Packet Idle mode. The base station may use paging channels to send a primary PWS notification. To ensure that all WTRUs associated with a base station receive the paging message transmitted by the base station, the base station may transmit the paging messages over all of the paging channels for a certain period of time to ensure all WTRUs in a discontinuous reception (DRX) mode may receive the paging message. The base station may choose to duplicate the transmission of the primary notification to ensure that all WTRUs receive it. In addition, if segmentation of the primary notification is necessary, the duplication may help a WTRU to receive the primary notification in any order.

Referring to FIG. 3, a plurality of WTRUs 310₁ . . . 310_{N} are in a DRX mode. This means that these WTRUs will periodically enter a sleep mode where each WTRU shuts down certain components to conserve battery power. During these DRX periods, the WTRU will not be listening to any paging channels and will therefore not be able to receive any PWS paging messages transmitted by base station 320. In order to ensure that WTRUs 310₁ . . . 310_{N} receive PWS paging messages, base station 320 transmits a PWS page message 330 using all paging channels available to base station 320 for a period of time long enough to ensure that all WTRUs in a DRX mode receive the PWS page message 330.

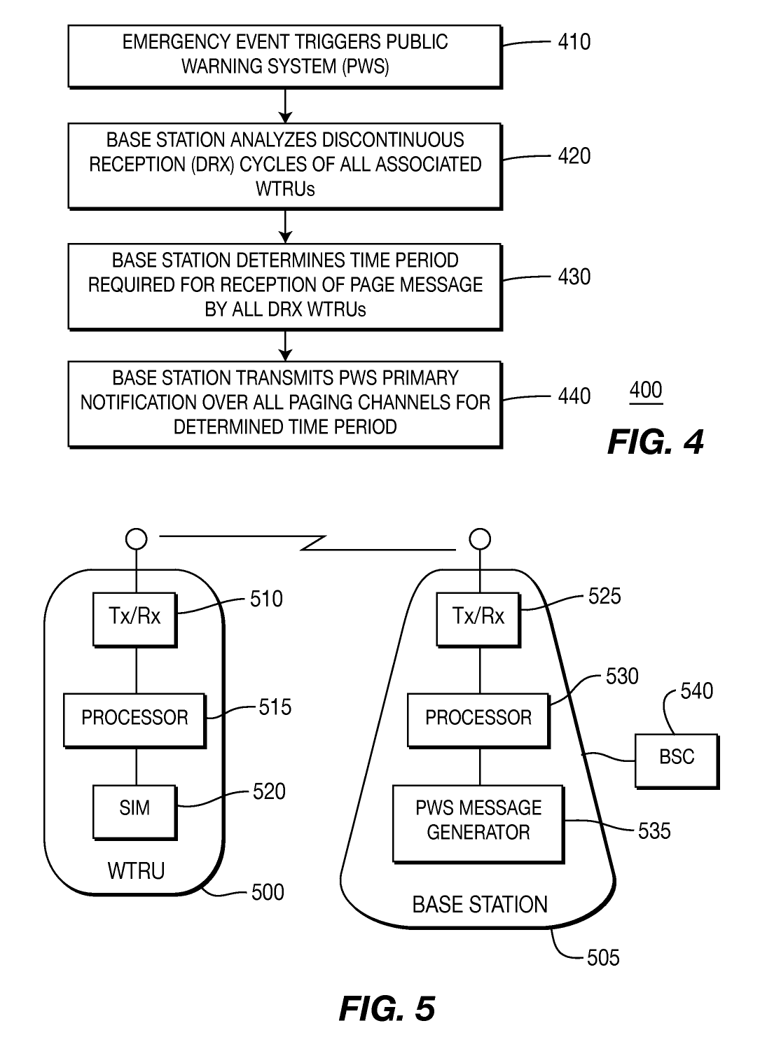

Referring to FIG. 4, a method 400 for transmitting PWS information via paging resources begins with an emergency event that triggers 410 the PWS. A base station analyzes 420 DRX cycles of all associated WTRUs. The base station then determines 430 the necessary time period required for reception of PWS paging message by all WTRUs associated with the base station. Finally, the base station transmits 440 a PWS primary notification over all paging channels for the determined time period so that all WTRUs associated with the base station, even those WTRU in DRX modes of operation.

In a scenario where a WTRU is in GSM Dedicated mode or GPRS Packet Transfer mode, the WTRU will have either a stand-alone Dedicated Control Channel (SDCCH), a traffic channel (TCH), or a GPRS radio resource which is called a Temporary block Flow (TBF). PWS information may be transmitted directly to the WTRU using these dedicated resources. In these cases, a base station may send a primary notification message to the WTRU using these dedicated resources.

In the case the WTRU has a TCH available, the TCH will always be accompanied by two control channels for signaling purposes, the Slow Associated Control Channel (SACCH) and the Fast Associated Control Channel (FACCH). The FACCH may be used in “stealing mode”, which is a well known concept in GSM systems and refers to the FACCH stealing from TCH resources in order to convey rapid and time sensitive signaling messages. It is noted that this “stealing mode” may also be used when a WTRU is in Dual Transfer Mode (DTM), as DTM operation includes the use of a TCH. The actual delivery of the notification may be accomplished by, for example, modifying an existing message or introducing a new message that is understood by the ETWS/PWS capable WTRUs.

In the case where a WTRU is in GPRS Packet Transfer Mode, the base station may transmit a new Radio Link Control/Medium Access Control (RLC/MAC) Control Block containing the primary PWS notification. This message may be read by all WTRUs that are multiplexed on the same Packet Data Channel (PDCH). For increased certainty, the base station may repeat the transmission of the RLC/MAC message over several radio blocks. The actual delivery of the notification may be accomplished by, for example, modifying an existing message or introducing a new message that is understood by the ETWS/PWS capable WTRUs.

Alternatively, SMS messaging may be used to transmit PWS notifications to a WTRU in GSM Dedicated mode or GPRS Packet Transfer mode. When a WTRU is in GSM Dedicated mode, SMS messaging may be received by the WTRU from the base station over FACCH or SDCCH resources. It is important to note that the SMS messages, for the WTRU in GSM dedicated mode, are normally sent over the SACCH. However, due to the slow nature of the SACCH, the use of FACCH for SMS delivery in this scenario will provide improved performance. When a WTRU is in Packet Transfer mode, the base station may first send a primary notification in a Control Block including a new RLC/MAC message to the WTRU. Upon receipt of the primary notification, the WTRU will ignore any downlink (DL) identity (such as DL temporary block flow (TBF)) if included in the radio block header of the following RLC/MAC data blocks. The WTRU will instead decode the blocks to obtain any additional PWS information. The base station may also use a distribution type message (such as a broadcast message) that does not include any particular identity in the header.

In a scenario where a WTRU is currently in GSM Idle mode or GPRS Idle mode, but the WTRU has requested dedicated resources and is awaiting assignment of dedicated resources, the following methods may be used for disseminating PWS information. Prior to sending the dedicated resources request message (which may be a Channel Request message, Packet Channel Request message, or EGPRS Packet Channel Request message, for example), the WTRU may read the “RACH Control Parameters” broadcast in the System Information messages. Among these parameters, the WTRU learns 1) how many times the WTRU may retry (Max Retrans) and during what time period the burst for retry can be sent (Tx-integer). The “Max Retrans” may be one of the four values {1, 2, 4, or 7}, which means that the WTRU may be in a retransmit situation for eight (total) attempts. The Tx-integer defines the time period between the attempts and the allowed interval during which the WTRU may transmit a new burst.

The WTRU may be under these conditions for several seconds. As an example, a typical value, picked by the operators, for the Tx-integer is 32 which then defines a range of 32 consecutive TDMA frames between 217 and 248 frames after the previously sent burst. Once the WTRU sends the burst including the request message, it starts monitoring the corresponding Common Control Channel (CCCH) in the DL in order to find a corresponding Assignment message (normally called the Immediate Assignment). This assignment message is received over the Access Grant Channel (AGCH) which is time multiplexed with the Paging Channel (PCH) over which the base station normally sends paging messages.

The WTRU may monitor the AGCH for the assignment message and the PCH to check whether the base station is broadcasting a PWS notification. If the WTRU detects any PWS notification, it aborts the Random Access procedure and processes the PWS information.

Alternatively, the base station may insert an indication (for example, in the form of an IE) into an assignment message transmitted to the WTRU (such as an Immediate Assignment message). The WTRU may then decode the assignment message and realize a PWS primary notification is included in the assignment message. The WTRU may then abort the normal dedicated resources assignment procedure and process the PWS information. It is noted that the various options described above for encoding PWS information may also apply to PWS notification via an assignment message.

The above described methods may be used in various combinations so that all WTRUs within a certain area receive PWS information. For example, PWS notifications (both primary and secondary) may be sent using any combination of SMS, CBS, Paging, BCCH, Multimedia Broadcast/Multicast Service (MBMS), or any combination thereof. PWS modes for primary and secondary notifications may be different. A base station may advertise the PWS delivery mode(s) through capability or configuration bits, bit fields, information elements in System Information, or extensions to CS or PS control messages sent to WTRUS. These indications announce which PWS mode is currently supported in a cell, group of cells, or the affected Public Land Mobile Network (PLMN). When multiple PWS delivery modes are available, a WTRU may select the appropriate delivery mode based upon its respective configuration and its respective PWS rules. These PWS rules may be a function of WTRU states (CS idle/connected, PS attached/idle) and/or WTRU activity (when in a CS call, when in a PS session, and the like). The PWS rules may also include priority of how a WTRU may attempt to monitor for the occurrence of PWS messages sent by a GSM/GPRS/EGPRS base station.

Referring to FIG. 5, a WTRU 500 and base station 505 are configured to implement a PWS as disclosed herein. The WTRU 500 includes a transceiver (Tx/Rx) 510, a processor 515, and optionally a SIM card 520. The base station 505 includes a transceiver (Tx/Rx) 525, a processor 530, and a PWS message generator 535. The base station 505 is in wired communication with a base station controller (BSC) 540, as well as additional network side components (not shown).

The base station 505 is configured to perform the various PWS methods disclosed above. For example, in the scenario where a WTRU is in GSM Idle mode or GPRS Idle mode, the base station 505 is configured broadcast System Information messages that include PWS primary notifications via Tx/Rx 525, as described above. The PWS message generator 535 is configured to generate the PWS messages, in combination with the processor 530. In another example, where paging resources are used for disseminating PWS information, the PWS message generator 535 in combination with the processor 530 perform the method 400 as described above with reference to FIG. 4. Certain emergency event triggers as well as DRX scheduling and other information may be received and stored in BSC 540. Base station 505 is also configured to operate a CBS, and PWS message generator 535 provides the necessary messages to the Tx/Rx 525 for broadcasting to associated WTRUs.

WTRU 500 is capable of receiving transmissions from various base stations via Tx/Rx 510, including PWS transmission. The processor 515 is capable of decoding received transmission to recover PWS information as described above. SIM card 520 may include stored PWS short codes that may be accessed by the processor 515 for decoding received PWS messages.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for use in a global system for mobile communications (GSM) enhanced data rates for GSM evolution (EDGE) radio access network (GERAN), the method comprising:
transmitting a public warning system (PWS) notification message indicating an occurrence of an emergency event to at least one wireless transmit/receive unit (WTRU) in GSM idle mode via a paging channel.

2. The method of claim 1, wherein the PWS notification message is a PWS primary notification message, the method further comprising:
transmitting a secondary PWS message to the at least one WTRU including information related to the emergency event specific to the at least one WTRU.

3. The method of claim 1, further comprising:
determining a time period to transmit the notification message to a plurality of WTRUs in a discontinuous reception (DRX) mode;
wherein the notification message is transmitted for the determined time period.

4. The method of claim 1, wherein a plurality of paging channels are available, and the PWS notification message is transmitted over all of the plurality of paging channels.

5. A method for use in a global system for mobile communications (GSM) enhanced data rate for GSM evolution (EDGE) radio access network (GERAN) compatible wireless transmit/receive unit (WTRU), the method comprising:
operating the GERAN WTRU in GSM idle mode; and
receiving a public warning system (PWS) notification message indicating the occurrence of an emergency event via a paging channel.

6. The method of claim 5, wherein the PWS notification message is a PWS primary notification message, the method further comprising:
receiving a secondary PWS message including information related to the emergency event specific to the GERAN WTRU.

7. The method of claim 5, wherein the GERAN WTRU is in a discontinuous reception (DRX) mode.

8. The method of claim 5, wherein a plurality of paging channels is available, and the PWS notification message is received over all of the plurality of paging channels.

9. A global system for mobile communications (GSM) enhanced data rates for GSM evolution (EDGE) radio access network (GERAN) base station, the base station comprising:
a processor configured to receive an indication of an occurrence of an emergency event; and
a transmitter configured to transmit a public warning system (PWS) notification message indicating the occurrence of the emergency event to at least one wireless transmit/receive unit (WTRU) in GSM idle mode via a paging channel.

10. The base station of claim 9, wherein the PWS notification message is a PWS primary notification message, and the transmitter is further configured to transmit a secondary PWS message to the at least one WTRU including information related to the emergency event specific to the at least one WTRU.

11. The base station of claim 9, wherein the processor is further configured to determine a time period to transmit the notification message to a plurality of WTRUs in a discontinuous reception (DRX) mode, and the transmitter is further configured to transmit the PWS notification message for the determined time period.

12. The base station of claim 9, wherein a plurality of paging channels are available, and the transmitter is configured to transmit the PWS notification message over all of the plurality of paging channels.

13. A global system for mobile communications (GSM) enhanced data rate for GSM evolution (EDGE) radio access network (GERAN) compatible wireless transmit/receive unit (WTRU) comprising:
a processor configured to operate in a GSM idle mode; and
a receiver configured to receive a public warning system (PWS) notification message indicating the occurrence of an emergency event via a paging channel.

14. The GERAN WTRU of claim 13, wherein the PWS notification message is a PWS primary notification message, and the receiver is further configured to receive a secondary PWS message including information related to the emergency event specific to the GERAN WTRU.

15. The GERAN WTRU of claim 13, wherein the GERAN WTRU is in a discontinuous reception (DRX) mode.

16. The GERAN WTRU of claim 13, wherein a plurality of paging channels are available, and the receiver is configured to receive the PWS notification message over all of the plurality of paging channels.

17. A method for use in a global system for mobile communications (GSM) enhanced data rate for GSM evolution (EDGE) radio access network (GERAN) compatible wireless transmit/receive unit (WTRU), the method comprising:
operating the GERAN WTRU in a GSM dedicated mode or dual transfer mode (DTM);
while in GSM dedicated mode or DTM, receiving a public warning system (PWS) notification message indicating the occurrence of an emergency event via a fast associated control channel (FACCH).

18. The method of claim 17, wherein the PWS notification message is included in a radio resource control (RRC) message.

19. A method for use in a global system for mobile communications (GSM) enhanced data rate for GSM evolution (EDGE) radio access network (GERAN) compatible wireless transmit/receive unit (WTRU), the method comprising:
operating the GERAN WTRU in a general packet radio service (GPRS) packet transfer mode;
while in GPRS packet transfer mode, receiving a radio link control/medium access control (RLC/MAC) control block containing a public warning system (PWS) notification message indicating the occurrence of an emergency event via a packet data channel (PDCH).

20. The method of claim 19, wherein the PWS notification message is included in a radio link control/medium access control (RLC/MAC) message.
